(19) United States
(12) Patent Application Publication
(10) Pub. No.: US 2004/0255990 A1
(43) Pub. Date: Dec. 23, 2004

(54) Method of and apparatus for golf club cleaning

(76) Inventor: Andrew M. Taylor, San Antonio, TX (US)

Correspondence Address: Stanley R. Moore, Esq., Jenkens & Gilchrist, P.C., Suite 3200, 1445 Ross Avenue, Dallas, TX, 75202-2799, US

(21) Appl. No.: 10/625,990

(22) Filed: Jul. 24, 2003

Related U.S. Application Data
(63) Continuation-in-part of application No. 09/793,723, filed on Feb. 26, 2001.
(60) Provisional application No. 60/398,243, filed on Jul. 24, 2002.

(51) Int. Cl. B08B 3/00

(52) U.S. Cl. 134/94.1; 134/172; 134/199

(57) ABSTRACT

A system for cleaning golf clubs having a detergent nozzle and rinse nozzle which move in a rectilinear fashion across the face of the golf club irons placed generally horizontally therein. The golf club irons may be placed generally horizontally in a right hand and left hand configuration such that the face of each golf club iron lies in grooves at an angle generally between 15 and 30 degrees relative to a detergent nozzle of a cleaning assembly. The generally trapezoidal lid is then closed around the golf club irons. As the lid is closed, complementary grooves form slots around the handle of the golf club irons. The golf club cleaning system may then be activated by inserting a coin into a control box . When activated, the cleaning system translates along a track assembly while the detergent nozzle imparts a stream of detergent from a detergent container to the faces of the golf club irons. Upon translating the length of the track assembly, the cleaning assembly activates the rinse nozzles and translates in the reverse direction along the track assembly while rinsing the detergent from the face of the golf club irons. The rinsed detergent is then drained through a drain connection.

### RELATED APPLICATION(S)

This application is a continuation-in-part of U.S. patent application Ser. No. 09/793,723 filed Feb. 26, 2001, and claims the benefit of U.S. Provisional application Ser. No. 60/398,243 filed Jul. 24, 2002, U.S. provisional application Ser. No. 60/184,881 filed Feb. 25, 2000 and U.S. patent application Ser. No. 09/793,723 filed Feb. 26, 2001 and incorporates the entirety thereof by reference herein. This application also incorporates by reference the following U.S. Patents, of which applicant is a co-inventor: U.S. Pat. No. 5,366,560 and 5,588,901.

### BACKGROUND OF THE INVENTION

1. Field of the Invention

The present invention relates to methods of and apparatus for cleaning, and more specifically, but not by way of limitation, to a golf club head cleaning system adapted for cleaning multiple golf club heads substantially at the same time.

2. History of Related Art

As set forth in Applicant's co-pending application Ser. No. 09/793,723, referenced above, high-pressure blast cleaning systems are well known. Such systems are often used to clean durable surfaces such as concrete and other material. They are also frequently used to remove such things as graffiti from building exteriors. Applicant has, however, also developed improvements in such systems and the like to facilitate the cleaning of golf clubs. In an effort to affect a more thorough cleaning, abrasives such as sodium bicarbonate may been added to power washers, and this has been found to be particularly advantageous in the cleaning of golf clubs, which, as described below, is of significance. Examples of such apparatus and methods of utilization are found in the above-referenced U.S. Pat. Nos. 5,366,560 and 5,588,901.

The sport of golf typically results in the collection of debris and dirt on the golf club heads and the need to clean the golf clubs. The use of traditional brush-and-bucket cleaning assemblies for cleaning golf club heads and the like is, however, replete with problems. First, the user must spend an inordinate amount of time cleaning an individual club by hand. Second, the components for cleaning typically involve a receptacle containing dirty or otherwise contaminated water, which the user must expose himself to in order to wash undesired elements off of his golf clubs. These undesired elements can vary greatly, and include such elements as fertilizer. Such materials can cause residue that can be left on the golf club heads by virtue of the contaminated rinse water. This is, in and of itself an issue of significance, because some fertilizer components can be used to make explosives. Golfers carrying clubs onto airplanes can inadvertently cause alarm if these “residue” components are detected during a security screening. The clubs should, therefore, be cleaned of such debris and undesirable elements. With old hard wash systems, however, the user typically drops a golf club completely into the dirty water, thereby coating the entire club with such residue. This can exacerbate the problem of fertilizer contamination. These are just a few of the many problems associated with conventional brush-and-bucket cleaning assemblies.

As referenced above, it is well known in the sport of golfing, that golf clubs can become very dirty and/or stained from a single round of play. Typically, both dirt and grass and/or other vegetation encountered by the golfer are often embedded into various areas of a golf club head. It is desirable to have the golf club cleaned in a manner that it is both efficient and reliable. It would also be advantageous to provide a manner for cleaning a series of golf clubs wherein the golf clubs could be placed in a generally horizontal manner in a cleaning system in any club order. Another advantage in cleaning multiple golf clubs of a golf club set would be to provide a method of and system for cleaning golf clubs that could receive either golf clubs for right-handed and left-handed players.

The present invention overcomes many of the disadvantages of known golf club cleaning systems by providing a method of and apparatus for receiving a plurality of golf clubs of the right and left-hand variety in a generally horizontal position and in no particular order. The golf clubs are situated in said generally horizontal position and aligned so that a substantially optimum angle is created between the golf club head surface to be cleaned and the cleaning apparatus. In this manner, a highly reliable and efficient system is created that affords the user a wider variety of advantages than heretofore possible.

### SUMMARY OF THE INVENTION

The present invention relates to a method of and apparatus for cleaning multiple golf club heads substantially at the same time. More particularly, the present invention pertains to a golf club cleaning system of the type having a nozzle assembly for a pressurized fluid stream for the generally horizontal receipt and placement of a plurality golf clubs with the heads thereof disposed beneath the nozzle. The invention includes an enclosure lid adapted for positioning over the golf clubs during the cleaning thereof The lid forms a spray enclosure in conjunction therewith and adapted for receiving the golf clubs in the generally horizontal position. In one embodiment, means are provided for discharging abrasives and/or pressurized fluid from the nozzle assembly. Further, means are provided for the rectilinear movement of the nozzle assembly above the golf club heads positioned within the spray enclosure. At least one rinse discharge nozzle is provided and adapted for spraying the golf club heads during the rectilinear movement of the nozzle assembly across the golf clubs.

In another aspect, the present invention is adapted for receipt of right and left handed golf clubs. Further, the rinse discharge nozzle assembly may include at least one detergent nozzle and at least one rinse nozzle. In yet another aspect, the spray enclosure is generally trapezoidal in shape.

In still another aspect of the invention, the means for the rectilinear movement of the nozzle assembly includes a grooved belt, a plurality of wheels coupled to the belt so as to impart tension to the belt, and a plurality of guide wheels coupled to the nozzle assembly. The guide wheels are matched to the grooves of the grooved belt for imparting rectilinear movement to the nozzle assembly.

In yet another aspect of the present invention, a pressurized fluid dispenser is positioned at the pressurized fluid receiving portion. The fluid dispenser is positioned so as to spray a substantially fan-shaped pressurized fluid jet across the abrasive and/or pressurized fluid chamber. The fluid jet has a width-wise axis and a height-wise axis, with the height-wise axis being measured substantially perpendicular to the width-wise axis. The fluid jet further includes two side-edge portions, one each on either of two sides and adjacent to an interior portion of the fluid jet. The fluid jet has a substantially uniform dispersion along the width-wise axis.

In yet another aspect, the invention includes a spray enclosure which has a substantially fan-shaped orientation so as to include the width-wise axis of the fluid. The spray enclosure has interior side walls configured to substantially align, with minimum interference, with the outer side-surfaces of the fluid jet.

In another aspect, the spray enclosure has a substantially truncated triangular shape oriented to include the widthwise axis of the fluid jet, and a truncated end forming an inlet for the receipt of pressurized fluid. The spray enclosure flares outwardly from the inlet to an exit, thereby maintaining a substantially uniform fluid dispersion.

In yet another aspect, a shut-off valve is provided for permitting, prohibiting and adjusting an abrasive load drawn into the abrasive and/or pressurized fluid entrainment chamber.

The present invention has several advantages over the known prior art. First, the system is relatively easy to use because an entire set of golf club irons may be placed in a generally horizontal position. Second, the system is automated, thus it requires less work to clean a set of golf club irons than certain cleaning systems. Third, the system may be designed such that the faces of the golf club irons are at an angle generally between 15 and 30 degrees to the detergent nozzle for optimum cleaning. Fourth, the system may be designed such that the golf club heads are cleaned generally between 30 to 90 seconds by adjusting the speed at which the nozzle assembly traverses the golf club heads. Finally, the system is adaptable for use with right and left handed golf club irons.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 is a perspective view of the golf club head cleaning system of the present invention;

FIG. 2 is a perspective view of the cleaning system shown in FIG. 1, with the lid in an open position;

FIG. 3 is a perspective view of the cleaning system shown in FIGS. 1 and 2, with the lid in a closed position having golf clubs placed in the cleaning system;

FIG. 4 is rear perspective view of the cleaning system shown in FIGS. 1, 2 and 3, with the rear portion of the cleaning system removed therefrom;

FIG. 5 is a frontal partial cutaway of the cleaning system of the present invention illustrating the cleaning assembly and the track assembly;

FIG. 6 is a top partial cutaway of the cleaning system illustrated in FIG. 5;

FIGS. 7 and 8 illustrate the manner of placement of right and left handed golf clubs into the cleaning system of the present invention;

FIG. 10 is a perspective view of the cleaning system set forth in applicant's co-pending U.S. patent application Ser. No. 09/793723, and labeled therein as FIG. 7;

FIG. 11 is a more detailed illustration of the cleaning system set forth in applicant's co-pending U.S. patent application Ser. No. 09/793723, and labeled therein as FIG. 8;

FIG. 12 is a perspective view of a back side of the cleaning system set forth in applicant's co-pending U.S. patent application Ser. No. 09/793723, and labeled therein as FIG. 9; and

Addendum A comprises co-pending U.S. Pat. No. 09/793,723 filed Feb. 26, 2001 of which this application is a continuation-in-part.

### DETAILED DESCRIPTION

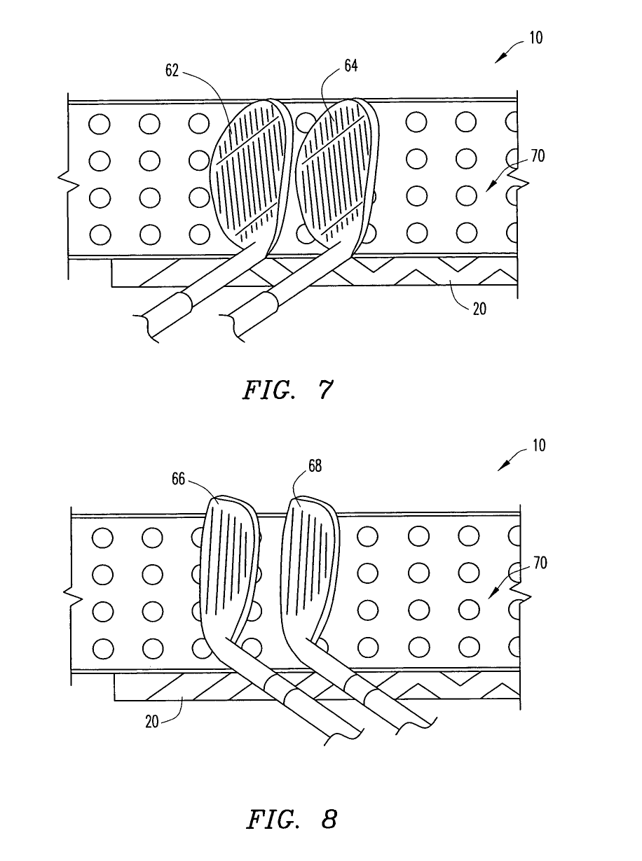

It has been found that a cleaning system affording the mounting of a plurality of golf clubs in a generally horizontal position within an apparatus generally no larger than that of a household washer machine, and utilizing a nozzle spray system designed to inject sodium bicarbonate and or other scouring/cleaning agents designed to remove dirt and debris but not adversely affecting the golf club surfaces is of considerable advantage. In general, the present invention provides for such an apparatus. The present invention described below provides a lid on the top of the apparatus that may be opened to accept the placement of a complete set of golf club irons of the right hand and left hand variety. After the clubs have been inserted into the apparatus and the lid closed, a pump or the like as described below may be actuated for driving a belt mechanism or the like coupled to a series of nozzles designed to inject the aforesaid sodium bicarbonate and/or other scouring cleaning agents designed to remove dirt and debris but not adversely affecting the golf club surfaces. As described below, other nozzles may be designed to spray water during a rinsing cycle for removing dirt and debris and other undesirable elements from the golf clubs and for rinsing the cleaning/scouring agents therefrom. To remove waste and cleaning agents expelled from the nozzles during the various cycles from the apparatus, a drain may be provided as described in more detail. Referring now to drawings 10, 11 and 12, which match Applicant's co-pending application Ser. No. 09/793,723, and labeled therein as FIGS. 7, 8, and 9, referenced above and incorporated herein by reference, one or more nozzle assemblies may be incorporated into a cleaning system for golf clubs. In this particular embodiment, a basic cleaning procedure is performed by the system therein described. The golf clubs as show therein are oriented generally vertically during the cleaning process, and the golf club heads are first scoured with high pressure abrasive and/or water from at least two angles. These angles of application of the cleaning solution upon the clubs are said to be established by the set orientation of the two nozzle assemblies therein.

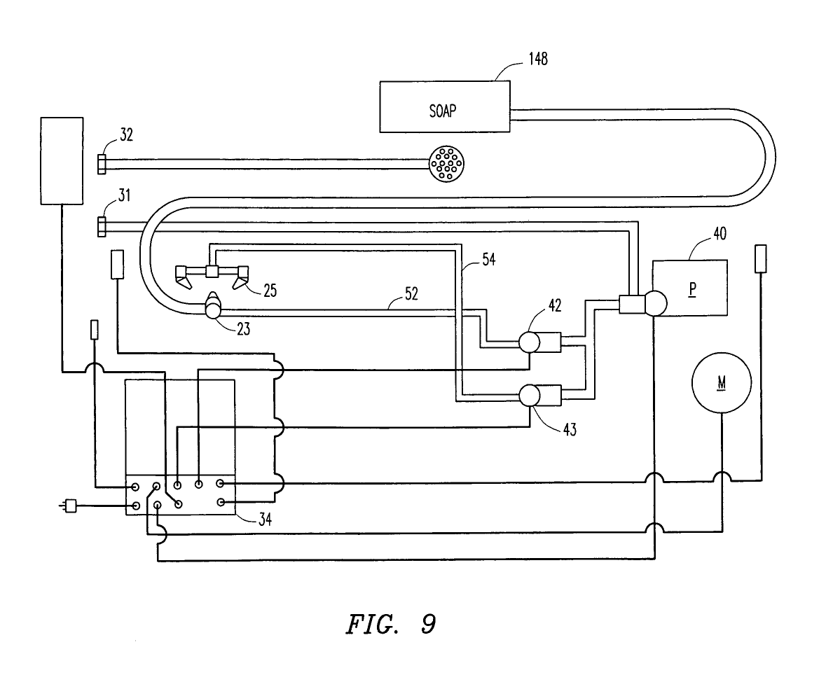

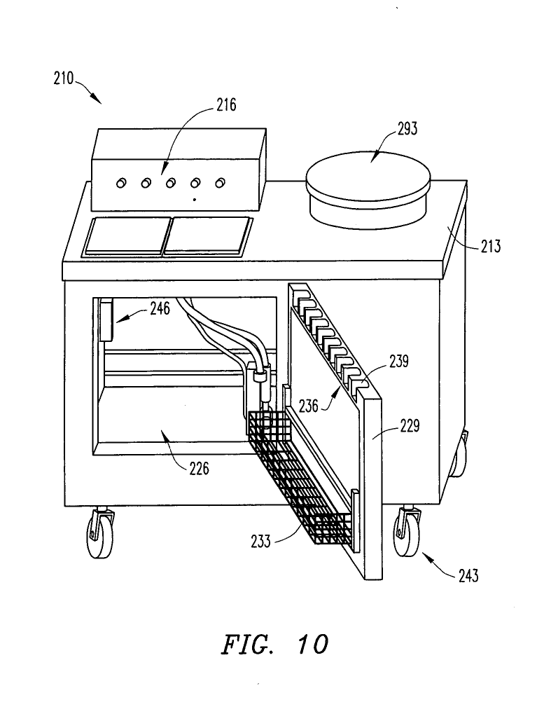

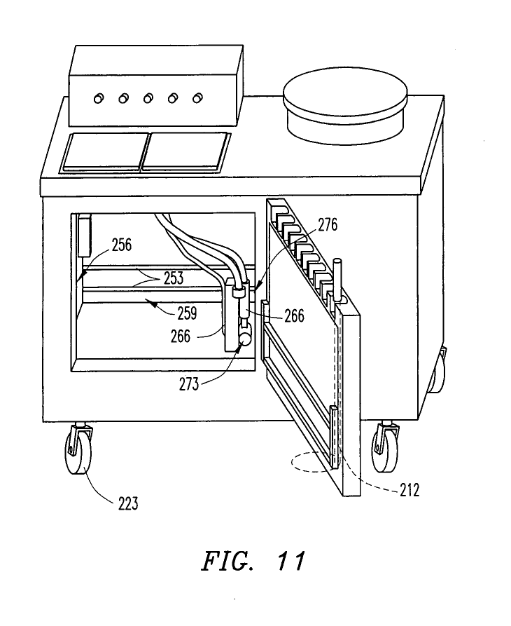

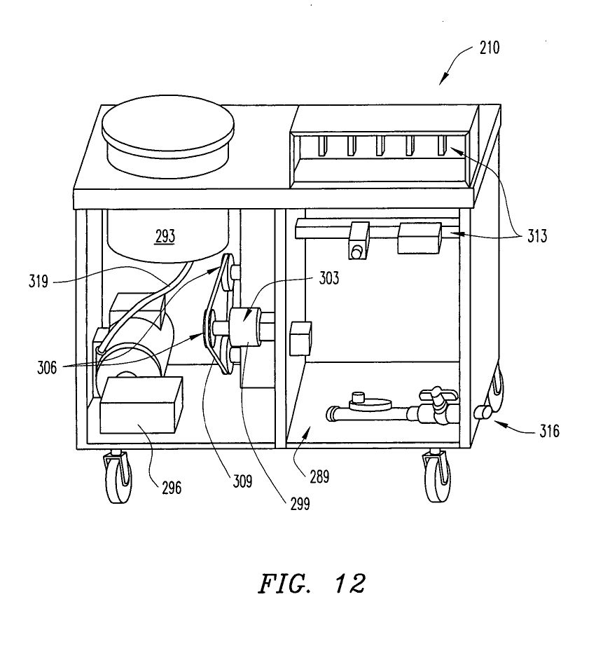

FIGS. 10 and 11 of said co-pending application, and labeled therein as FIGS. 7 and 8, illustrate a front side view of the cleaning system wherein a hinged door is provided to allow access to the interior space. Other aspects of the operation thereof are set forth and described and the reference hereto are made for purposes of clarity in describing the improved system as now set forth by the inventor. Multiple changes including a horizontal holding rack allowing placement of the clubs in a generally horizontal position in a top loaded system facilitate a myriad of advantages relative to the cleaning operation.

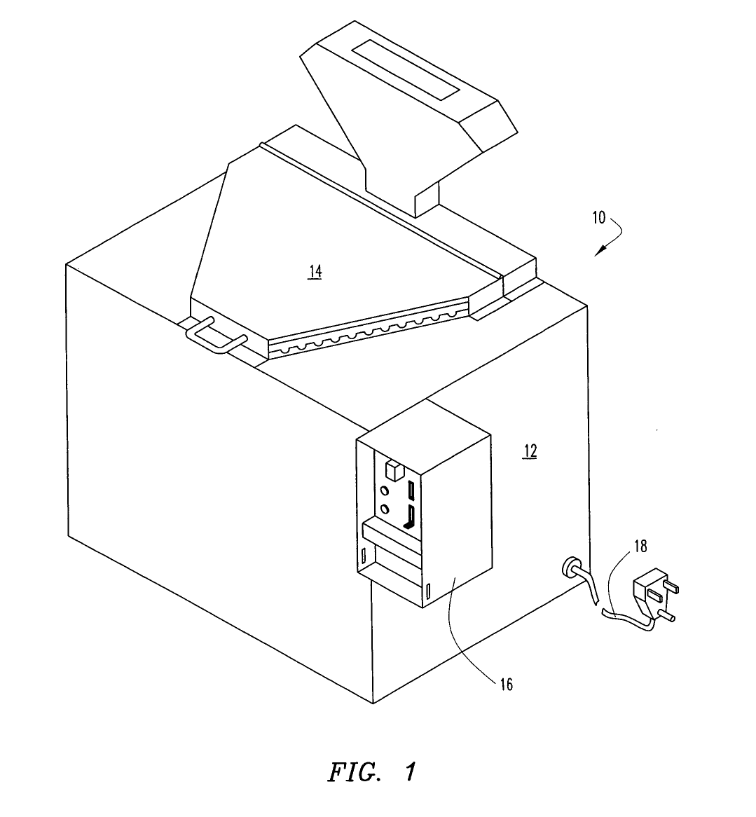

Referring now to the drawings in the present application, and, more particularly to FIG. 1, there is shown a perspective view of the golf club head cleaning system 10 illustrated without the receipt of golf clubs therein. The system 10 includes a body portion 12 and lid 14 hingely connected thereto. The lid 14 is of a generally trapezoidal shape, and in this particular embodiment, adapted for receiving golf clubs of the right hand and left hand variety, as will be described in more detail below. A control box 16 is likewise shown protruding outwardly of body 12 and adapted for receiving coins for the actuation thereof. A power cord 18 is shown extending from body 12 for purposes of providing power to the system 10.

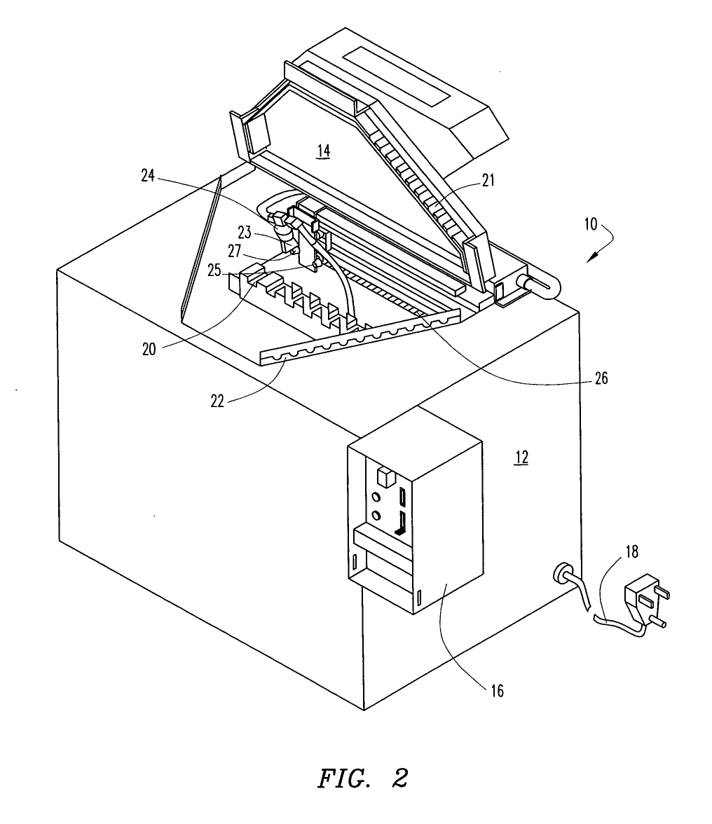

Referring now to FIG. 2, there is shown a perspective view of an exemplary embodiment of the golf club cleaning system 10, illustrated in FIG. 1, with the lid 14 in an open position. In FIG. 2 there is shown a series of interlocking triangular protrusions forming grooves 20 and a notched surface forming grooves 22. Notched surface grooves 21 on lid 14 are complementary to grooves 22 to facilitate the closing of lid 14 around golf club irons. Grooves 20 and 22 are adapted for the receipt left and right handed golf club irons in a generally horizontal position therein. As the lid 14 is placed in a closed position (as shown in FIG. 1), an abrasive and/or pressurized fluid entrainment chamber is formed around the golf club irons, preventing the flow of waste outside the system 10.

Also shown in FIG. 2 is a nozzle assembly 24, which includes detergent nozzle 23 and rinse nozzles 25 and 27. A more detailed description of the design of nozzle 23 may be found in said co-pending application. As system 10 begins a cleaning cycle, nozzle assembly 24 moves in a rightward direction relative to the system 10 along a grooved belt of a track assembly 26, with nozzle 23 spraying a detergent onto the face of the golf club irons. When nozzle assembly 24 reaches the end of track assembly 26, the faces of the golf club irons are rinsed of the detergent by rinsing nozzles 25 and 27, as the nozzle assembly 24 translates in a leftward direction. Grooves 22 and 20 are positioned relative one to the other such that the golf club faces are stored in system 10 at an angle generally between 15 to 30 degrees to the nozzle 23. This results in the optimum cleaning of the golf club faces. Further, the system 10 may be designed such that the golf clubs are cleaned generally between 30 to 90 seconds by adjusting the speed at which the nozzle assembly 24 traverses the golf club heads.

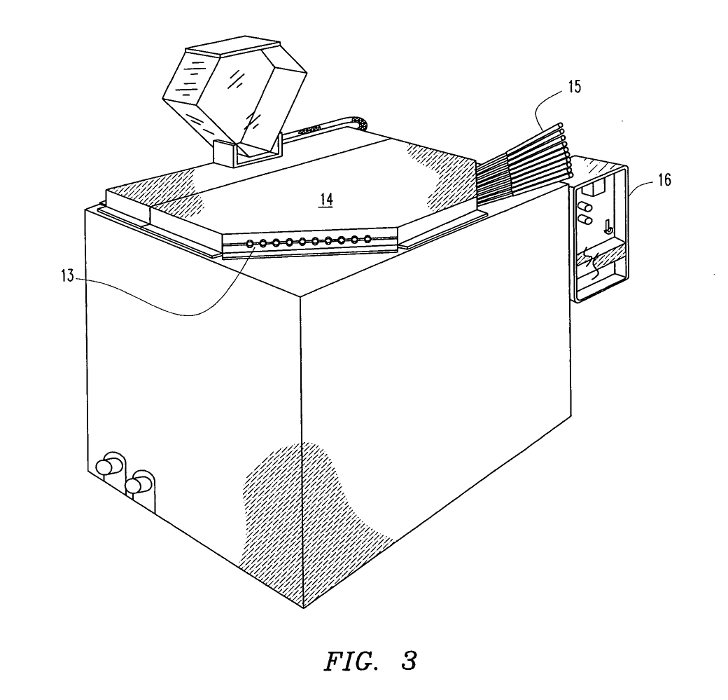

Referring now to FIG. 3, there is shown an exemplary embodiment of the golf club cleaning system 10 of FIGS. 1 and 2 with golf club irons 15 placed in a generally horizontal position therein for cleaning. In this embodiment, the golf club irons 15 are placed in a position for cleaning right hand golf club irons. However, if the golf club irons 15 were of a left hand variety, the golf club irons 15 may be placed in slots 13 for proper cleaning.

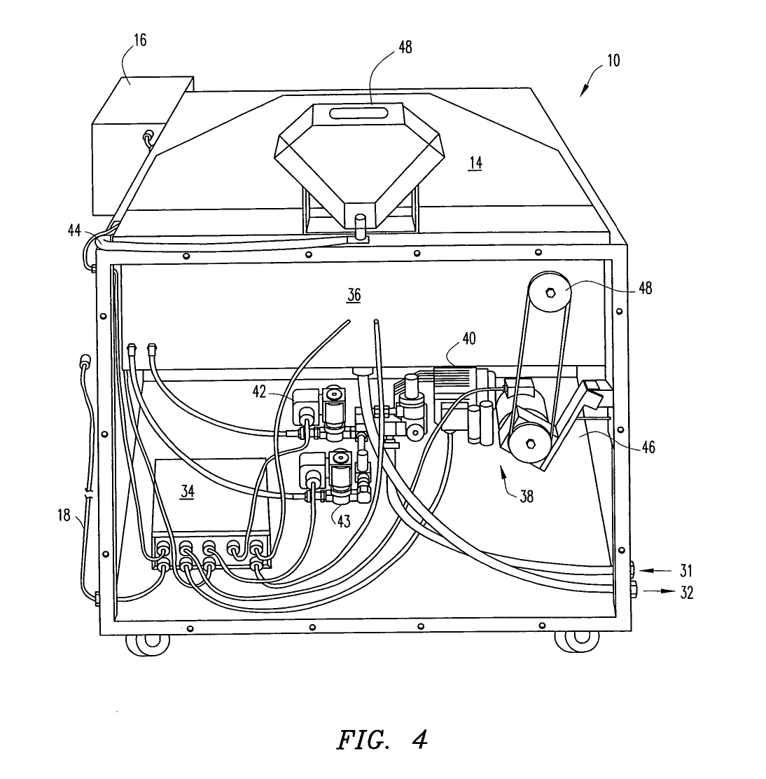

Referring now to FIG. 4, there is illustrated a rear perspective view of the golf club cleaning system 10, illustrated in FIGS. 1-3. The system 10 may include inlet connection 31 and drain connection 32, both connected to an external source and drain respectively. A back plate 36 may be provided to protect the electrical and mechanical components of the system 10 from damage of water and/or detergent. A motor 38 moves nozzle assembly 24 (not shown) along track assembly 26 (not shown) of FIG. 2 via a belt assembly 48.

Referring again to FIG. 4, a pump 40 is provided for pumping water from inlet connection 31 to nozzle assembly 24 (shown in FIG. 2) at a sufficient pressure to facilitate the proper cleaning of golf clubs by golf club cleaning system 10. Valves 42 and 43 supply water from inlet connection 31 to cleaning and rinse nozzles 23, 25, and 27 of nozzle assembly 24 (shown in FIG. 2). A hose 44 is a fluid connection between the detergent nozzle 23 of nozzle assembly 24 (shown in FIG. 2) and detergent container 48. Fluid utilized by the cleaning system 10 is drained through the drain connection 32.

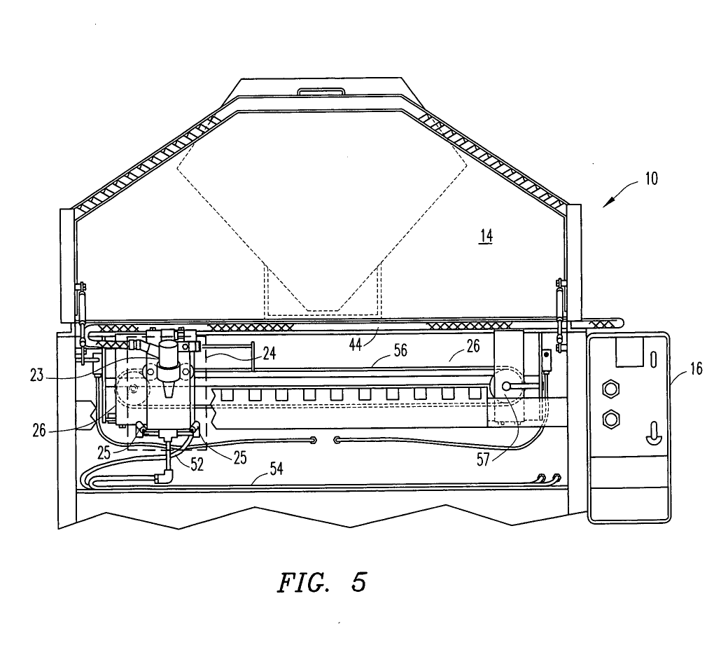

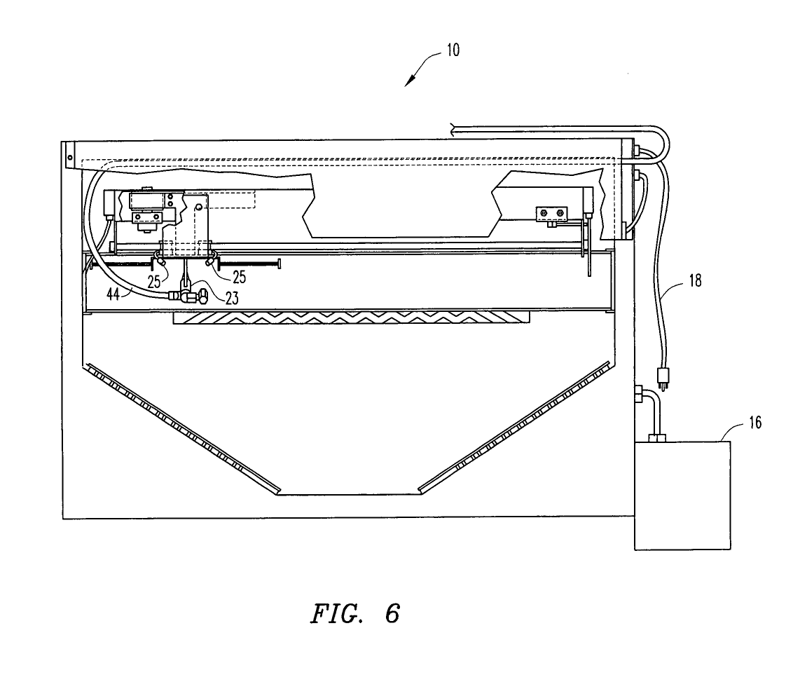

Referring now to FIGS. 5 and 6 in combination, there is shown an exemplary embodiment of a top and side partial cutout view of the golf club cleaning system 10 according to the present invention. Detergent nozzle 23 along with rinse nozzles 25 and 27 are in fluid connection with inlet connection 31 (shown in FIG. 3) via lines 52 and 54. Detergent nozzle 23 is further connected to a detergent via line 44. Nozzle assembly 24 moves along the front faces of the golf clubs stored in the golf club system 10 via track assembly 26. Specifically, wheels 56, which are attached to nozzle assembly 24, move along a belt 56 as wheels 26 are rotated by motor 38 (shown in FIG. 3).

With reference now to FIGS. 7 and 8 in combination, there is shown an exemplary embodiment of the placement of golf club irons in the interlocking triangular protrusions forming grooves 20 of the golf club cleaning system 10. Left handed clubs are shown placed in the grooves 20 in FIG. 7, and right handed clubs are shown placed in grooves 20 in FIG. 8. The shape of the interlocking triangular protrusions forming grooves 20 allows the use of both right and left handed clubs with the golf club cleaning system 10 of the present invention. A plurality of holes 70 forming a waste drain is connected to the drain connection 32 of FIG. 3.

Referring now to FIG. 9, there is shown a schematic illustrating an exemplary embodiment of the fluid and electrical connections of the golf club cleaning system 10 according to the principles of the present invention. As can be seen from FIG. 9, water from inlet valve 31 is pumped by pump 40 through a splitter into valves 43 and 42. Water flowing through valve 42 is in fluid connection with detergent nozzle 23 via tube 52, and water flowing through valve 43 is in fluid connection with rinsing nozzles 25 and 27 via tube 54. Further, detergent nozzle 23 is in fluid connection with detergent container 48 via tube 44.

In operation, a set of golf club irons are placed in the golf club cleaning system 10 according to the principles of the present invention. The golf club irons may be placed generally horizontal in a right hand and left hand configuration such that the face of each golf club iron lies in grooves 20 and 22 at an angle generally between 15 and 30 degrees relative to detergent nozzle 23 of the nozzle assembly 24. The lid 14 is then closed around the golf club irons. As the lid 14 is closed, complementary grooves 21 and 22 form slots 13 around the handle of the golf club irons. Golf club cleaning system 10 may then be activated by inserting a coin into control box 16. When activated, the cleaning system 20 translates along track assembly 26 while detergent nozzle 23 imparts a stream of detergent from detergent container 48 to the faces of the golf club irons. Upon translating the length of track assembly 26, nozzle assembly 24 activates the rinse nozzles 23 and 27 and translates in the reverse direction along track assembly 26 while rinsing the detergent from the face of the golf club irons. The rinsed detergent is then drained through drain connection 32.

The golf club cleaning system 10 according to the principles of the present provides at least the following advantages over the known prior art. First, the system 10 is relatively easy to use because an entire set of irons is placed in the system 10 in a generally horizontal position. Second, the system 10 is automated, thus requiring less work to clean a set of golf club irons than certain cleaning systems. Third, the system 10 may be designed such that the faces of the golf club irons are at an angle generally between 15 and 30 degrees to the detergent nozzle 23 for optimum cleaning. Fourth, the system may be designed such that the golf club heads are cleaned generally between 30 to 90 seconds by adjusting the speed at which the nozzle assembly traverses the golf club heads. Finally, the system 10 is adaptable for use with both right and left handed golf club irons.

The previous description is of a preferred embodiment for implementing the invention, and the scope of the invention should not necessarily be limited by this description. The scope of the present invention is instead defined by the following claims.

What is claimed is:

1. A golf club cleaning system of the type having a nozzle assembly for a pressurized fluid stream, said system comprising:
positioning means adapted for the generally horizontal receipt and placement of a plurality golf clubs with the heads thereof disposed beneath said nozzle;
an enclosure lid adapted for positioning over said golf clubs during the cleaning thereof with said nozzle assembly and comprising a spray enclosure in conjunction therewith adapted for receiving said golf clubs in said generally horizontal position;
means for providing a high pressure stream for discharge with said pressurized fluid from said nozzle assembly;
means for the rectilinear movement of said nozzle assembly above said preposition golf club heads positioned within said spray enclosure for receipt of said pressurized fluid; and
at least one rinse discharge nozzle adapted for spraying said golf club heads during said rectilinear movement of said nozzle assembly across said golf clubs positioned in said generally horizontal position.

2. The system according to claim 1, wherein the high pressure stream includes an abrasive.

3. The system of claim 2, wherein said positioning means of said plurality of golf clubs is adapted for receipt of right and left handed golf clubs

4. The system of claim 3, wherein said rinse discharge nozzle assembly comprises at least one detergent nozzle and at least one rinse nozzle.

5. The system of claim 4, wherein said spray enclosure is generally trapezoidal in shape.

6. The system of claim 5, wherein the means for the rectilinear movement of said nozzle assembly further comprises:
a grooved belt;
a plurality of wheels coupled to said belt so as to impart tension to said belt; and
a plurality of guide wheels coupled to said nozzle assembly, said guide wheels matched to the grooves of said grooved belt for imparting rectilinear movement to said nozzle assembly.

7. The golf club cleaning system as recited in claim 1, further comprising:
a pressurized fluid dispenser positioned at said pressurized fluid receiving portion and arranged to spray a substantially fan-shaped pressurized fluid jet across said abrasive entrainment chamber, said fluid jet having a width-wise axis and a height-wise axis, said height-wise axis being measured substantially perpendicular to said width-wise axis;
said fluid jet having two side-edge portions, one each on either of two sides and adjacent to an interior portion of said fluid jet; and
said fluid jet having a substantially uniform dispersion along said width-wise axis.

8. The golf club cleaning system as recited in claim 7, further comprising said spray enclosure being substantially fan-shaped in a plane oriented to include said width-wise axis of said fluid jet and perpendicularly intersecting said height-wise axis of said fluid jet, said spray enclosure having interior side walls configured to substantially align, with minimum interference, with outer side-surfaces of said fluid jet.

9. The golf club cleaning system as recited in claim 8, said spray enclosure further comprising:
a substantially truncated triangular-shape in said plane oriented to include said widthwise axis of said fluid jet and perpendicularly intersecting said height-wise axis of said fluid jet; and a truncated end forming an inlet for pressurized fluid directed therein to, said spray enclosure flaring outwardly from said inlet to an exit thereof along said plane thereby maintaining a substantially uniform fluid dispersion across said width-wise axis.

10. The golf club cleaning system as recited in claim 9, further comprising said spray enclosure having top and bottom walls that converge toward one another from said inlet to said exit along said height-wise axis for focusing said fluid jet and thereby facilitating said maintenance of said substantially uniform fluid dispersion across said width-wise axis.

11. The golf club cleaning system as recited in claim 10, further comprising a shut-off valve arranged across said access port for permitting, prohibiting and adjusting an abrasive load drawable into said abrasive entrainment chamber.

12. A high pressure entraining assembly for a pressurized fluid stream, said assembly comprising:
a pressurized fluid receiving portion adapted to accommodate a pressurized fluid dispenser;
an abrasive entrainment chamber oriented to accept pressurized fluid jetted thereacross from the pressurized fluid dispenser, said abrasive entrainment chamber adapted to establish a venturi suction responsive to pressurized fluid being jetted thereacross;
an access port in fluid communication between said abrasive entrainment chamber and an abrasive metering assembly, said access port adapted to permit suction of abrasive into said abrasive entrainment chamber for entrainment in a pressurized fluid being jetted thereacross;
said abrasive metering assembly comprising a ball valve positioned at a juncture between an air intake, an abrasive supply and said access port for controlling fluid communication therebetween; and
a ball member of said ball valve being adapted to regulate an amount of abrasive permitted to be deployed from said abrasive supply into air taken up through said air intake.

13. The assembly as recited in claim 12, wherein said air intake further comprises: a variably adjustable closure member adapted to increase and decrease air amounts permitted to be drawn through said air intake by rotation of said closure member.

14. The assembly as recited in claim 13, wherein said closure member further comprises:
a threaded cylindrical portion adapted to be threadedly received in a tapped receiver in said abrasive metering assembly; and
at least one inlet aperture extending through a side wall of said closure member and arranged to have a degree of openness adjusted by rotation of said closure member.

15. The assembly as recited in claim 14, said abrasive metering assembly further comprising a housing body having an abrasive supply inlet extending therethrough and arranged to communicate with an abrasive inlet aperture through said ball member of said ball valve when said abrasive entraining assembly is in an abrasive dispensing configuration.

16. The assembly as recited in claim 15, said ball member further comprising: an open cylinder extending therethrough and arranged to align with said abrasive supply inlet in an abrasive blocking configuration; and said open cylinder arranged to form a flow-through channel across said abrasive metering assembly in an abrasive dispensing configuration.

17. The assembly as recited in claim 16, further comprising: said inlet aperture extends through a wall of said open cylinder and is arranged to dispense abrasive into said abrasive entraining assembly when said abrasive metering assembly is in an abrasive dispensing configuration.
